(19) United States
(12) Patent Application Publication
(10) Pub. No.: US 2010/0308230 A1
(43) Pub. Date: Dec. 9, 2010

(54) DETECTOR ARRAY SUBSTRATE AND NUCLEAR MEDICINE DIAGNOSIS DEVICE USING SAME

(75) Inventors: Norihito YANAGITA, Hitachi (JP); Tomoyuki SEINO, Hitachi (JP); Takafumi ISHITSU, Hitachi (JP); Tsutomu IMAI, Hadano (JP); Atsumi KAWATA, Hiratsuka (JP); Shinya KOMINAMI, Mito (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/857,950

(22) Filed: Aug. 17, 2010

Related U.S. Application Data
(63) Continuation of application No. PCT/JP2009/052626, filed on Feb. 17, 2009.

(30) Foreign Application Priority Data
Feb. 22, 2008 (JP) 2008-040853

(51) Int. Cl. G01T 1/161; G01T 1/24

(52) U.S. Cl. 250/370.09

(57) ABSTRACT

Provided are a detector array substrate and a nuclear medicine diagnosis device using the same. The detector array substrate is provided with a flat detection module stacked in plural detection elements, which is connected to said detectors each other, and have signal electrodes for reading out signals of respective detectors, and bias electrodes for applying bias voltage to respective detectors, in order to form plural detectors for detecting radiation; and stacked with the detectors by arranging the detection modules having the plural detectors, in an X direction, as well as by arranging the detection modules in a flat structure on both planes or one plane of a wiring board in a Z direction as for an XZ plane for detecting the radiation, and provided with the plural detection modules in a Y direction.

### BACKGROUND OF THE INVENTION

1. Technical Field

The present invention relates to a nuclear medicine diagnosis device utilizing radiation and, in particular, the present invention relates to a detector array substrate and a nuclear medicine diagnosis device using the same suitable for Positron Emission computed Tomography (hereafter referred to as “PET”), or the like.

2. Background Art

A device for administering drugs labeled with an RI (a radioisotope) to a subject such as a patient, detecting γ-ray emitted from the RI, and acquiring RI distribution in the subject is generally called a nuclear medicine imaging device. A typical one of the nuclear medicine imaging device includes a γ-camera, a single photon emission computed tomography (SPECT) device, a PET device or the like.

The γ-camera is a device for measuring γ-ray emitted from inside of the subject by a plane-type detector, and imaging plane distribution thereof, and is attached with a collimator at the front of the detector to limit an incident direction of γ-ray to give directionality.

The SPECT is a device for detecting γ-ray emitted from inside of the subject by arranging plane-type detectors similar to the γ-camera around the subject, and imaging a body axis tomography image etc. of RI distribution, by imaging processing similarly to an X-ray CT. The SPECT, similarly as in the γ-camera, is also attached with a collimator at the front of the detector to limit an incident direction of γ-ray. The RI to be used in the SPECT is a nuclide emitting single γ-ray, and for example, ^{99m}Tc or ¹²³I or the like is used, and circulation among organs and metabolism information can be known by imaging these RI distributions.

The PET device is a device for detecting γ-ray emitted from inside of the subject by a ring-like detector arranged at the circumference of the subject, and imaging a body axis tomography image or the like of RI distribution by imaging processing. Pair annihilation γ-ray of 511 keV are used as detection targets, which are emitted in nearly opposite direction) (180°±0.6° in annihilation by emitting β⁺ and binding with an electron, by administering radioactive drugs labeled with a positron (β⁺) emission nuclide.

The PET device can estimate incident directions of two annihilation γ-ray, when γ-ray detected at the same timing are selected by a coincidence circuit, therefore, unlike the γ-camera and the SPECT, it is not necessary to use a mechanical collimator. The positron emission nuclide to be used in PET imaging includes ¹⁸F, ¹⁵O, ¹¹C or the like. For example, because a tumor tissue has fierce glucose metabolism and accumulates highly glucose, when a fluorodeoxyglucose (2-[F-18]fluoro-2-deoxy-D-glucose, ¹⁸F-FDG), which is a drug (a kind of glucose) labeled with ¹⁸F, is administered into the subject, ¹⁸F of a tracer also accumulates at the tumor tissue. From a PET image of this time, a tumor site can be specified quantitatively.

Conventionally, in the nuclear medicine diagnosis device, as a detector for detecting γ-ray, a scintillator mainly composed of a substance such as bismuth germanium oxide (BGO) or thallium-doped sodium iodide (NaI(Tl)) has been used. γ-ray injected to this detector is once converted to very weak light using the scintillator, and this very weak light is converted to electric signals using a photoelectron multiplier or a photodiode or the like. Therefore, there has been a problem of leading to large sizing of the nuclear medicine imaging device.

Consequently, at present, semiconductor detectors composed of a semiconductor cell such as cadmium telluride (CdTe) or cadmium zinc telluride (CdZnTe) have been watched. These semiconductor detectors convert γ-ray directly to charge carriers (electrons and positive holes). Therefore, because γ-ray can be detected by each semiconductor cell, compact-sizing and weight-reduction of a device can be expected as compared with the case using the scintillator and the photoelectron multiplier. In addition, number of charge carriers to be generated is far more as compared with number obtained by the scintillator detector, which means that good energy resolution can be obtained. It should be noted that, energy resolution means capability of detecting energy value of γ-ray in good precision. For example, it means capability of detecting γ-ray of 511 keV, as an energy of 511 keV correctly.

By the way, in order to obtain a highly precise image in the PET device, which is a kind of the nuclear medicine diagnosis device, there is a demand to enhance a spatial resolution. In addition, in the PET device, there is a demand to enhance γ-ray detection sensitivity, for example, to increase arrangement density of radiation detectors to shorten examination time. It should be noted that, detection sensitivity means capability of detecting many γ-ray in a predetermined energy window.

These demands are present also in the nuclear medicine diagnosis device other than the SPECT device and the γ-ray camera. As a detector array means therefor, as shown in FIG. 5 of JP-A-2007-78369, the detection module composed of a structure, where a semiconductor radiation detection element is stacked in multiple pieces via a metal plate, is arranged, so that a stacked plane becomes vertical to the wiring board.

### SUMMARY OF THE INVENTION

As described above, features of the semiconductor detector is good energy resolution, and good energy resolution leads to advantage of high-definition and high quantitative property in image diagnosis. And, this advantage becomes far more conspicuous with enhancement of spatial resolution and detection sensitivity. It should be noted that spatial resolution means capability of precisely detecting emission position of γ-ray.

On the other hand, the semiconductor element represented by CdTe is generally sensitive to mechanical impact or defect, and for convenience of protection thereof, it is necessary to protect and support a surface with a metal plate as shown in FIG. 5 of JP-A-2007-78369, or the like, and is attached to a substrate after fixing a metal plate onto the semiconductor element.

In addition, in the case of mounting extremely large number of detectors onto the wiring board, as in the PET device, it is desirable to be handled in an automatic mounting device in view of cost reduction. In this case, however, in consideration of mounting position error of a device, it is necessary to provide a certain clearance, so that each of the detection modules does not come into contact with.

Presence of such a metal plate or clearance could incur dead space in γ-ray detection, that is, decrease in detection sensitivity and spatial resolution. Therefore, it has been desired a detection element, a module and a detector array substrate which can minimize such problems.

In view of the above circumstances, it is an object of the present invention to provide a detector array substrate which is capable of enhancing detection sensitivity and spatial resolution, and a nuclear medicine diagnosis device using the same.

The detector array substrate of a first present invention is a detector array substrate arranged with detection elements for detecting a radiation by converting to electric signals, in an XYZ space formed by a Z direction, which is the same direction as a body axis of a subject, a Y direction, which is nearly the same direction as an incident direction of radiation from a radioactive material in the subject, and an X direction, which is vertical to a ZY plane formed by the Z direction and the Y direction, which provides a flat detection module stacked in plural thr detection elements, which is connected to the detectors each other, and have signal electrodes for reading out signals of the respective detectors and bias electrodes for applying bias voltage to the respective detectors, in order to form plural detectors for detecting the radiation; stacks the detectors by arranging the detection modules having the plural detectors in the X direction, as well as by arranging the detection modules in a flat structure on both planes or one plane of the wiring board in the Z direction, as for the XZ plane for detecting the radiation; and provides the plural detection modules in the Y direction.

The nuclear medicine diagnosis device of a second present invention is provided with a detector array structure where the detector array substrate of the first present invention is arranged in multiple in a Z direction.

### ADVANTAGES OF THE INVENTION

According to the present invention, a detector array substrate which is capable of enhancing detection sensitivity and spatial resolution, and a nuclear medicine diagnosis device using the same can be realized.

Other objects, features and advantages of the present invention will become apparent from the following description of the examples of the invention relating to the accompanying drawings.

### BRIEF DESCRIPTION OF THE DRAWINGS

FIG. 1 is a perspective view showing a PET device of a nuclear medicine diagnosis device, which is an embodiment of the present invention.

FIG. 2 is a concept view of the A-A cross-section of FIG. 1, showing a major structure of a detection unit for detecting an annihilation γ-ray pair in a gantry of a PET device during examination of a subject (shown by dash-dot-dot in FIG. 1).

FIG. 3 is a magnified perspective view, when one detector array substrate shown in FIG. 2 is viewed from the B direction.

FIG. 4 is a magnified perspective view of a detection module mounted on a wiring board of the detector array substrate shown in FIG. 3.

FIG. 5 is a perspective view showing a detection element configuring a detection module.

FIG. 6 is a perspective view showing assembly of a detection module.

FIG. 7 is a perspective view showing a detector array substrate of a modified embodiment.

### DESCRIPTION OF THE EMBODIMENTS

Explanation will be given next in detail on best embodiments for carrying out the present invention, with reference to accompanied drawings.

### <<A Whole Configuration of the Pet Device 1>>

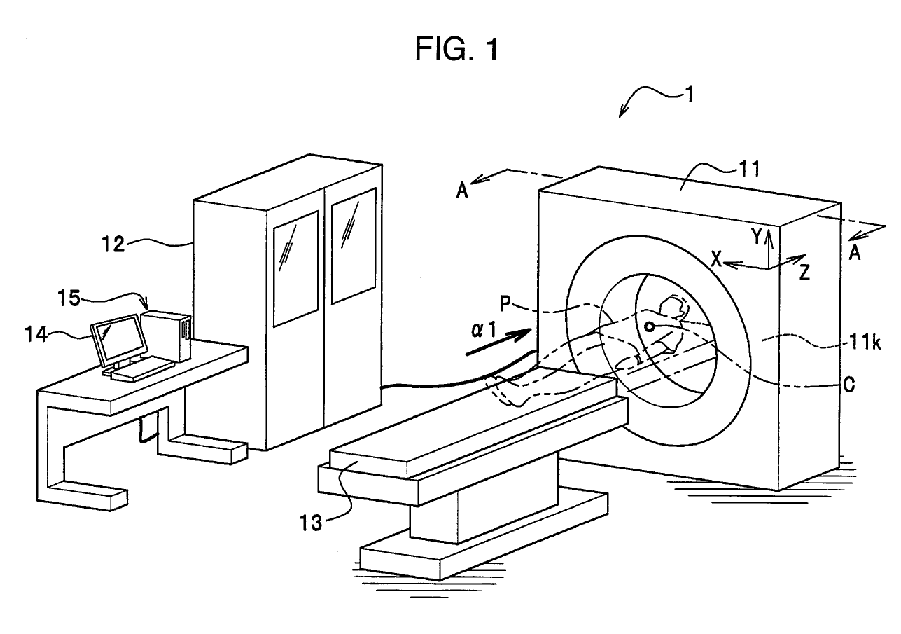

The PET device 1 of the nuclear medicine diagnosis device, which is one embodiment of the present invention, is configured by provided with, as shown in FIG. 1, a bed 13 where subject P such as a patient administered with drugs labeled with a positron emission nuclide lies in examination; a gantry 11 for measuring an annihilation γ-ray pair G emitted from an accumulation part C of the positron emission nuclide in body of subject P body after transferring the subject P on the bed 13 in an α1 arrow direction; a data processing device 12 for performing collection and analysis of a data, based on signals acquired and processed by the gantry 11; a display device 14 for displaying results collected and analyzed at the data processing device 12; and an I/O operation device 15 having a keyboard or the like. It should be noted that, FIG. 1 is a perspective view showing a whole configuration of a PET device 1.

In the present description, the I/O operation device 15 having the display device 14 or the like is arranged outside of an examination room (not shown), where at least the gantry 11, the bed 13 or the like is arranged, so as to avoid a laboratory technician operating the I/O operation device 15 being exposed to radiation.

### <<The Detector Array Substrate 30 of a Detection Unit 11k in the Gantry 11>>

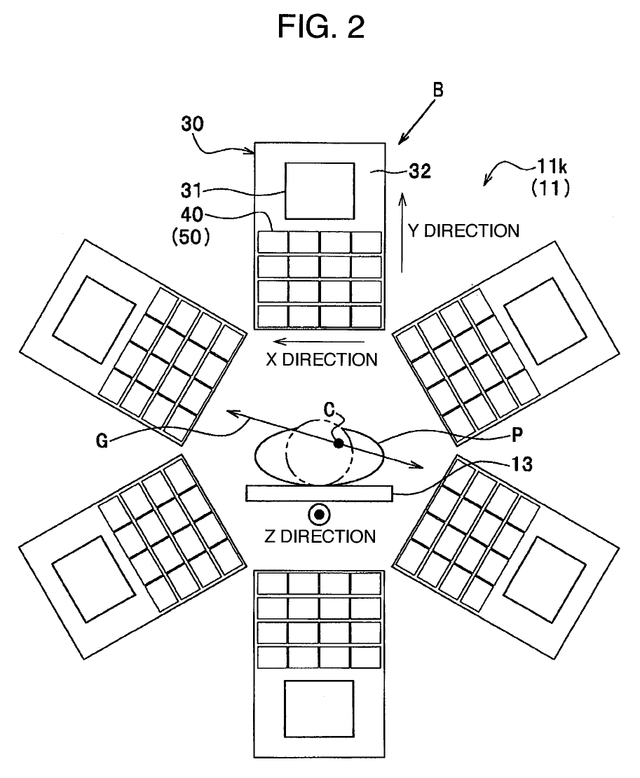

FIG. 2 is a concept view of the A-A cross-section of FIG. 1, showing a substantial part structure of a detection unit 11k for detecting an annihilation γ-ray pair in the gantry 11 of the PET device 1 in examination of the subject P (shown by double-dashed line in FIG. 1).

As shown in FIG. 2, the detection unit 11k in the gantry 11 is provided with the detector array substrate 30 having, a plurality of detection modules 40 having the detection element 50 of the CdTe (cadmium telluride) semiconductor for detecting γ-ray from the accumulation part C of the positron emission nuclide in the subject P and a signal processing unit 31 for processing detection signals by γ-ray of the detection modules 40, in an opposing embodiment each other the subject P on the bed 13 as nearly the center, and making total 6 pairs.

In the present description, by taking a configuration where the detector array substrates 30 oppose each other around the subject P as nearly the center, data analysis relating to position of the accumulation part C of the positron emission nuclide becomes easy. It should be noted that, the detector array substrates 30 may also be configured without opposing each other.

In the present description, an X direction, a Y direction and a Z direction, shown in FIG. 1, FIG. 2 or the like, are defined as follows.

A Z direction, shown in FIG. 1 and FIG. 2 (direction vertical to the paper plane of FIG. 2) refers to the same direction as the body axis direction of the subject P.

And, the detector array substrates 30 having the detection modules 40 are arranged in a Z direction (direction vertical to the paper plane of FIG. 2), that is, in a circular pattern around the body axis direction of the subject P; an X direction of FIG. 2 means the circumferential direction with the subject P in the PET device 1 as the center, that is, the tangential direction; and a Y direction of FIG. 2 means the diameter direction with the subject P as the center, that is, the direction where the annihilation γ-ray pair emitted from the accumulation part C of the positron emission nuclide in the subject P injects, mainly.

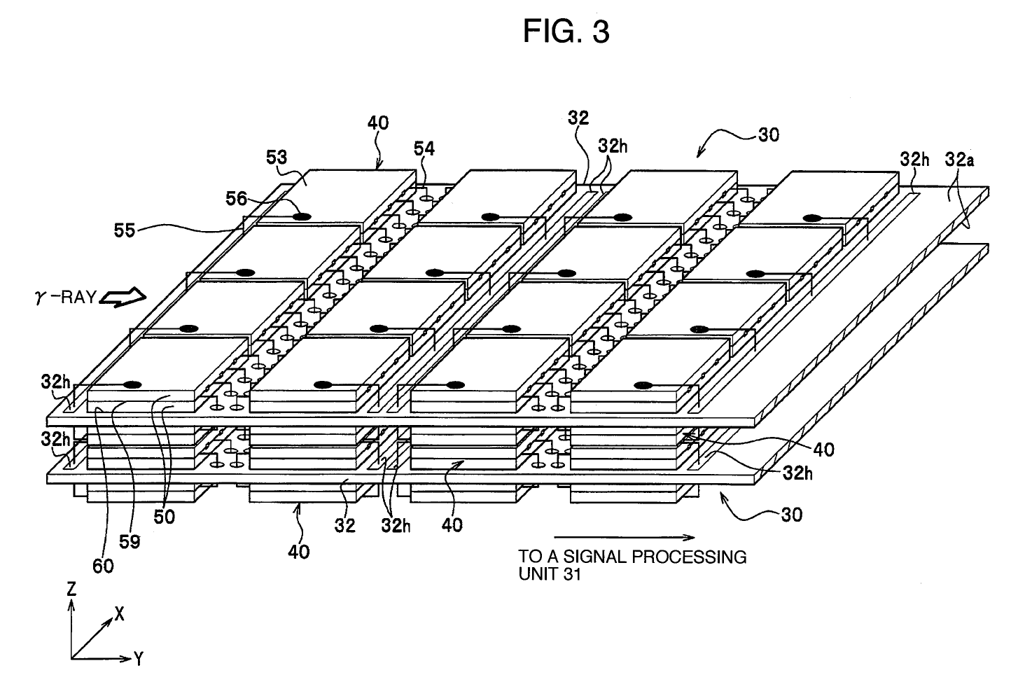

In the present description, because the detector array substrates 30 are shown in planar figure in FIG. 2, the detector array substrates 30 are viewed in an overlapped way in the vertical direction in the paper plane of FIG. 2, however, this detector array substrates 30 are arranged in multiple in the body axis direction of the subject P, that is a Z direction (refer to FIG. 3; a perspective drawing viewed from the B direction of the detector array substrates 30 of FIG. 2,) and the detector array substrates 30 in the PET device 1 makes a three-dimensional structure.

Because electric signals corresponding to quantity or energy of radiation can be detected, when voltage is applied to the CdTe semiconductor, configuring this detection module 40, the single crystal of the CdTe semiconductor of the detection module 40 absorbs γ-ray in good efficiency and directly converts them to electric signals, and thus provides high detection sensitivity and good energy resolution of γ-ray.

The signal processing unit 31 of the detection module 40 to be mounted on the detector array substrates 30 shown in FIG. 2, is configured by a signal processing circuit or the like, and after performing waveform shaping and amplification of the electric signals output from the detection module 40 by incidence of γ-ray, performs signal processing such as analogue-digital conversion of wave height of the voltage signals (which corresponds to energy of γ-ray), amplifier address-detector XY address conversion, acquisition of data time information, and real time wave height calibration for correcting characteristics of thickness or the like of individual CdTe semiconductor detection element.

### <<The Detection Module 40 of the Detector Array Substrate 30>>

FIG. 3 is a magnified perspective view, when one detector array substrate 30 shown in FIG. 2 is viewed from the B direction, and the signal processing unit 31 is omitted.

It should be noted that, in FIG. 3, when the signal processing unit 31 is shown, the signal processing unit 31 shall be shown at the right side of the paper plane, and in addition, γ-ray from the accumulation part C of the positron emission nuclide inject to the detector array substrates 30 from the left to the right, in FIG. 3.

As shown in FIG. 3, the detector array substrate 30 arranges four pieces of the detection modules 40 in an X direction (the obliquely back surface side from the surface side of the paper plane of FIG. 3), corresponding to the circumference direction (refer to FIG. 2) around the subject P of the PET device 1, in addition, four pieces in a Y direction (the left and right direction in the paper plane of FIG. 3) where γ-ray injects mainly; and in total two pieces at both planes of the wiring board 32 of a Z direction (the upper and the lower directions in the paper plane of FIG. 3) of the body axis direction of the subject P; and mounts each of the detection modules 40 in a flat structure onto the wiring board 32 using the conductive adhesives 60.

As shown in FIG. 3, by mounting the detection modules 40 in a flat structure onto the wiring board 32, adhesive area of the detection modules 40 and the wiring board 32 increases, resulting in enabling to support the detection modules 40, which is brittle in view of strength, with high strength.

In the present description, in FIG. 3, the case where this detector array substrate 30 was arranged in two pieces stacked in a Z direction, is shown.

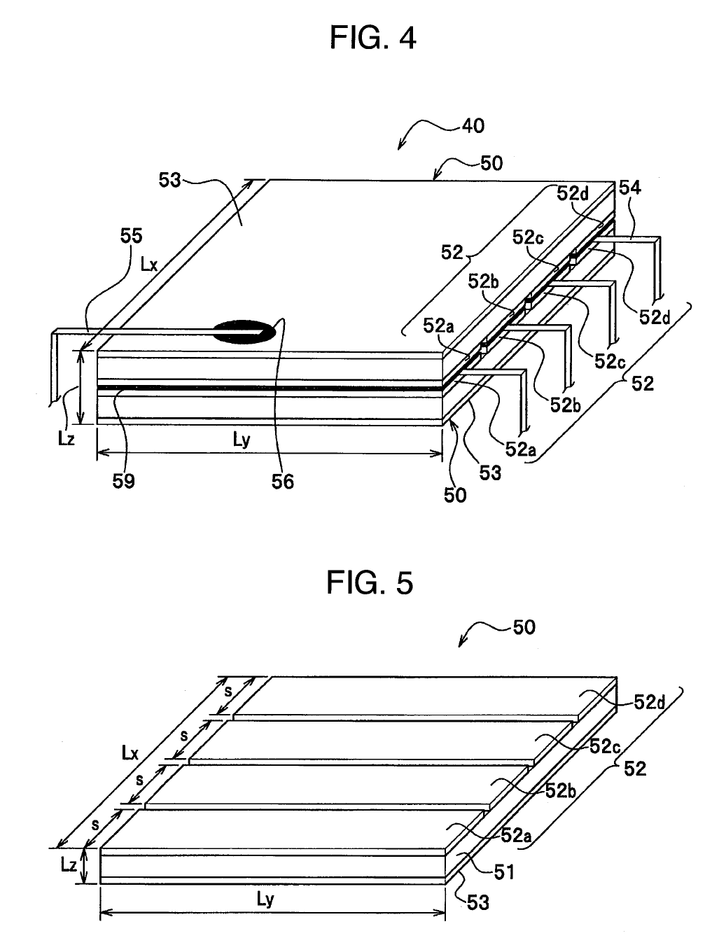

FIG. 4 is a magnified perspective view of a detection module 40 mounted on a wiring board 32 of the detector array substrate 30 shown in FIG. 3, and FIG. 5 is a perspective view showing a detection element 50 configuring a detection module 40.

As shown in FIG. 4, the detection module 40 is configured by lamination using the conductive adhesives 59, in an embodiment that each of the signal electrode 52 (52a, 52b, 52c, 52d) at one plane side faces each other, by making two sheets of the detection element 50 shown in FIG. 5 opposed to the anode each other. Therefore, the upper and lower end parts (the upper and lower plane sides of the detection module 40 shown in FIG. 4) of the detection module 40 are the cathodes, and the bias electrodes 53 are formed at the upper and lower planes.

### <<A Detection Element 50 Configuring the Detection Module 40>>

In the detection element 50 configuring the detection module 40, as shown in FIG. 5, the signal electrode 52 (52a, 52b, 52c, 52d), which are pattern-coated in four division using conductive In (indium), are formed at one direction of a CdTe semiconductor crystal 51 composed of CdTe (cadmium telluride), as well as the bias electrodes 53, which are difficult to be oxidized and are coated with conductive Pt (platinum), are formed at the other whole plane of the semiconductor crystal 51. This detection element 50 forms a flat cuboid and has a length of, for example, Lx=10 mm, Ly=10 mm and Lz=1 mm.

In examination time of the subject P by the PET device 1 shown in FIG. 2, each of the signal electrodes 52 divided into four of the one direction of the semiconductor crystal 51 of the detection element 50, is an anode side electrode for catching electric signals converted from γ-ray in the CdTe semiconductor crystal 51, and a reversed bias voltage of several hundred V is applied onto the bias electrodes 53 in cathode side of the other direction of the semiconductor crystal 51 of the detection element 50, in a direction of Lz=1 mm thickness. In this time, the voltage of the anode side signal electrode 52 is nearly 0 volt.

### <<Assembly of the Detection Module 40>>

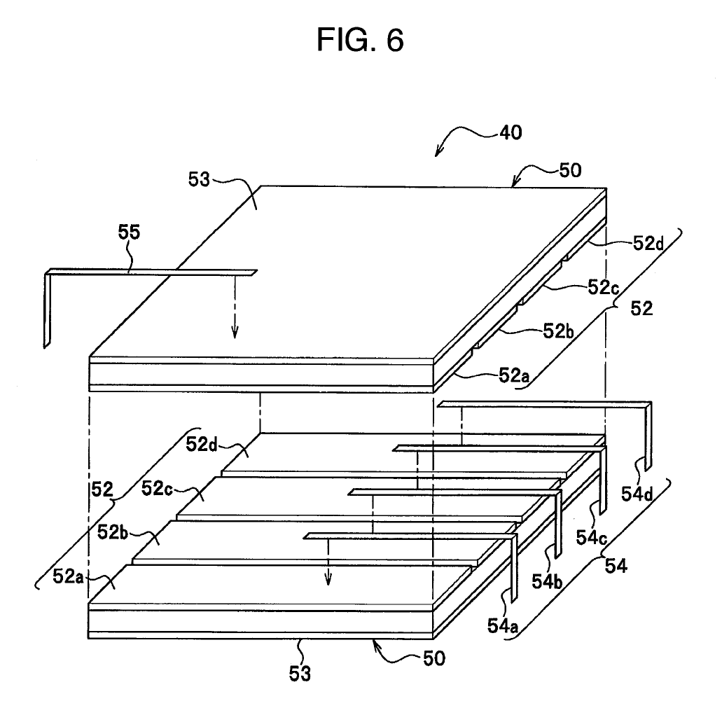

FIG. 6 is a perspective view showing assembly of the detection module 40.

In configuring the detection module 40 using the detection element 50, as shown in FIG. 6, a pair of the detection elements 50 is laminated using the conductive adhesives 59, by making the signal electrode 52 (52a, 52b, 52c, 52d) of the anode side opposed so as to face each other, and in this time, by sandwiching the copper ribbon-like or wire-like conductors 54 (54a, 54b, 54c, 54d) with a thickness of about several ten μm between a pair of the signal electrodes 52 (52a, 52b, 52c, 52d), respectively. It should be noted that, by using the ribbon-like signal electrode 52 as a wiring from the signal electrode 52, length between the detection elements 50 to be laminated is narrowed, and spatial resolution in a Z direction shown in FIG. 2 enhances.

And, as shown in FIG. 6, the conductor 55 for applying reversed bias voltage is connected onto the surface of the bias electrodes 53 of the upper detection element 50, using the conductive adhesives 56 to configure the detection module 40 shown in FIG. 4.

As shown in FIG. 4, because the detection module 40 laminates the wide planes themselves, where the signal electrode 52 of the two detection elements 50 is present, adhesive area becomes wide, and strength is increased as a flat-like detection module 40.

In examination time by the PET device 1 shown in FIG. 2, as shown in FIG. 4, reversed bias voltage is supplied to the bias electrodes 53 of the detection element 50 at the outward direction (the upper side in FIG. 4) using the conductor 55, as well as reversed bias voltage is supplied to the bias electrodes 53 of the detection element 50 at the inward direction (the lower side in FIG. 4), using a wiring (not shown) formed onto the wiring board 32 (refer to FIG. 3).

And, detection signals by γ-ray injected to the detection element 50 are read out via each of the copper ribbon-like or wire-like conductors 54a, 54b, 54c, 54d and each of the signal electrodes 52a, 52b, 52c, 52d of the detection module 40.

In this way, one detection module 40 with a length of Lx=10 mm, Ly=10 mm and Lz=2 mm shown in FIG. 4, is one having four γ-ray detection units (hereafter referred to as a detection channel), that is, four detectors, and length per each one detection channel becomes ¼ Lx=2.5 mm, Ly=10 mm and Lz=2 mm

In the present description, by shortening the length of an X direction of the detector to ¼ Lx=2.5 mm, spatial resolution in an X direction during examination, shown in FIG. 2, can be enhanced. In addition, by lengthening the length of a Y direction of the detector to Ly=10 mm, enhancement of SN ratio of the detection signals of the detector can be attained.

The detection module 40 (refer to FIG. 4) of this configuration, as described above and as shown in FIG. 3, at one plane 32a and the other plane 32a of the wiring board 32, respectively, is arranged by four pieces in an X direction (the obliquely back surface side from the surface side of the paper plane of FIG. 3, refer to FIG. 2) of the circumference direction (refer to FIG. 2) around the subject P in examination of the PET device 1; in addition, is arranged by four pieces in a Y direction (the left and right direction in the paper plane of FIG. 3; refer to FIG. 2), where γ-ray injects mainly, and in addition, is mounted by one piece in a Z direction of the body axis direction (the upper and the lower directions in the paper plane of FIG. 3) of the subject P, onto the wiring board 32, using the conductive adhesives 60.

As understood from FIG. 3, the detection module 40 is mounted onto the wiring board 32, so that the plane 32a of the wiring board 32 and the electrode plane of the bias electrodes 53 of the detection module 40 are in parallel (corresponding to an XY plane: refer to FIG. 2. That is, the detection module 40 is configured so as to have a flat structure relative to the wiring board 32, and thus the detection module 40, which is brittle in view of strength, is supported by the wiring board 32 at a wide plane where the bias electrodes 53 are present, and enhancement of strength of the detection module 40 is devised.

<<The Wiring Board 32 Mounted with the Detection Modules 40>>

As shown in FIG. 3, the wiring board 32 mounted with the detection modules 40 is a multi-layer wiring board having a wiring (not shown) for the signal electrode 52 to read out signals, and a wiring 32h for the bias electrodes 53 to apply bias voltage, or the like, and each wiring is formed independently by embedding the wiring inside the wiring board 32 or the like. In addition, at the deep inside of a Y direction, where γ-ray injects mainly, in the wiring board 32, there is present the signal processing unit 31 (omitted in FIG. 3; refer to FIG. 2).

Each conductor 54 for the signal electrode 52 to be connected to each of the signal electrodes 52 (52a, 52b, 52c, 52d) (refer to FIG. 4) extends in a Y direction (the left and right direction in the paper plane of FIG. 3), where γ-ray injects mainly, and is connected to a wiring (not shown) for signal current formed onto the wiring board 32 by the conductive adhesive.

In addition, as for the bias electrodes 53 to contact directly with the wiring board 32 of the detection modules 40, it is face-bonded directly to the wiring board 32 using conductive adhesives without using a conductor, and is connected to a wiring (not drawing) for the bias electrode formed onto the wiring board 32.

The conductor 55 for the bias electrodes 53 at the upper part of each detection module 40 extends in a Y direction (the left and right direction in the paper plane of FIG. 3), where γ-ray injects mainly, and is connected to a wiring 32h for bias voltage formed onto the wiring board 32 by conductive adhesives.

As understood from FIG. 3, the whole conductor for connecting the conductors 54 for the signal electrode 52 (52a, 52b, 52c, 52d) of each detection module 40, and the conductors 55 for the bias electrodes 53, is connected to the wiring board 32 in a form along a Y direction where γ-ray injects mainly.

In this way, for example, in FIG. 3, there are 32 pieces of the detection modules 40 in total, per one piece of the detector array substrate 30: that is, 4 pieces in an X direction of the circumference direction (refer to FIG. 2) of the PET device 1×4 pieces in a Y direction where γ-ray injects mainly×2 pieces in a Z direction of the body axis direction (refer to FIG. 2) of the subject P.

Therefore, because the detection channel has four copper ribbon-like or wire conductors 54a, 54b, 54c and 54d per one detection module 40, and has four channels, it is a structure that the detection module 40 contains at least 129 wirings, which is composed of 32 pieces×4 channels=128 channels, that is, 128 pieces of wirings for reading out signals, and one piece of wiring for applying bias voltage (32h or the like), in the wiring board 32. It should be noted that, because the wiring for applying bias voltage applies reversed bias voltage with the same potential, the wiring for applying bias voltage is enough to be one piece.

In the present description, in mounting the detection module 40 in a Y direction (refer to FIG. 3 and FIG. 2), where γ-ray injects mainly, it is desirable that the detection module 40 is mounted on the wiring board 32, while making them facing alternately, so that the CdTe semiconductors of the same type, that is with the same potential, face together.

The reason is that because the conductors 54 for the signal electrode has a potential of nearly 0 volt, and the conductors 55 for the bias electrode has a potential of several hundred volt, placing them in facing position eliminates risk of breakdown caused by high voltage, which thus provides easier narrowing of space between the detection modules 40 of a Y direction of a direction, where γ-ray injects mainly, and thus density of the CdTe semiconductor enhances, resulting in enhancement of detection sensitivity of γ-ray.

It should be noted that, supply of reversed bias voltage to the bias electrodes 53 of the detection module 40 naturally allows exchange of positions for an anode and a cathode of the detection element 50.

In addition, in the present embodiment, the case, where the two detection elements 50 (refer to FIG. 4) were stacked on the wiring board 32 by making the anodes opposed, was exemplified, however, similarly it is possible to stack appropriately arbitrary number of the detection element 50 by making the anode or the cathode of the detection element 50 opposed.

### <<A Variant Embodiment>>

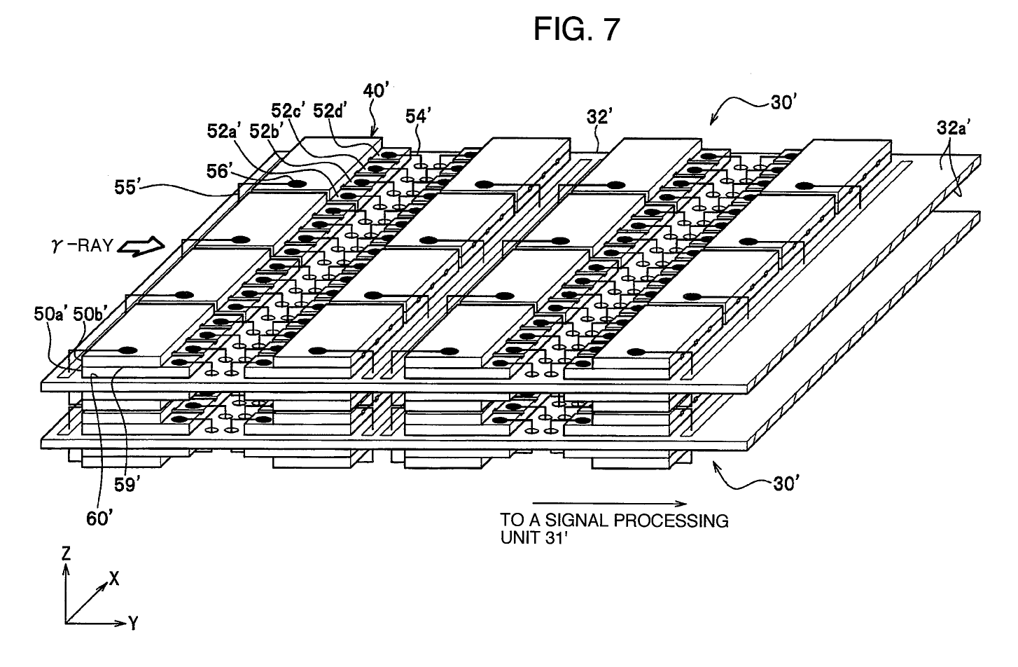

Explanation will be given next on a variant embodiment, with reference to FIG. 7.

It should be noted that, FIG. 7 is a perspective view showing a detector array substrate 30′ of a variant embodiment.

The detector array substrate 30′ of the variant embodiment shown in FIG. 7 is a structure with enhanced detection sensitivity and spatial resolution, specialized to a Z direction of the body axis direction of the subject P (refer to FIG. 1 and FIG. 2).

The detector array substrate 30′ of the variant embodiment uses a detection modules 40′ laminated with detection elements 50a′ and 50b′ having different length of a Y direction (the left and right direction in the paper plane of FIG. 7) of a direction, where γ-ray injects mainly. In the detection modules 40′, a conductor 54′ for a signal electrode 52′ is pulled out from the signal electrode 52′ (52a′, 52b′, 52c′, 52d′) at a place where the detection element 50a′ having longer length is protruded from the detection element 50b′ having shorter length, to read out the signals.

Because a configuration other than this is similar to the embodiment, a configuration element similar to the embodiment is shown by attaching ‘(dash) to a code of the embodiment, and detailed explanation is omitted.

According to this configuration, in lamination of the detection elements 50a’ and 50b′, because of absence of the conductors 54′ between the detection elements 50a′ and 50b′, thickness can be eliminated by an amount of the conductors 54′ in the detection modules 40′, resulting in enhancement of density of the CdTe semiconductor of a Z direction (refer to FIG. 1 and FIG. 2) of the body axis direction of the subject P.

In addition, because a conductor 54′ is pulled out from the signal electrode 52′ exposed outward of a place where the detection element 50a′ having longer length is protruded from the detection element 50b′ having shorter length, in the detection module 40′, the conductors 54′ can be wired easily.

### <<Summary>>

In disposing the detectors of the embodiment, as shown in FIG. 5, the patterned detection elements 50 having the signal electrode 52 (52a, 52b, 52c, 52d) of plural read-out electrodes are used. As shown in FIG. 4, the detection elements 50 are laminated and stacked, so that the signal electrodes 52 (52a, 52b, 52c, 52d) of reading-out electrodes each other face, to prepare the detection module 40, and has a structure which is capable of reading out γ-ray detection signals of plural channels from one detection module 40.

And, as shown in FIG. 3, the detection modules 40 is mounted on the wiring board 32, so that the plane 32a, where the wiring board 32 extends, and each of the signal electrodes 52 (52a, 52b, 52c, 52d) and 53 of the detection element 50 are in parallel. In the present description, the plural detection modules 40 are installed in Y direction, which is orthogonal to a plane (an XZ plane) where γ-ray injects mainly. That is, the detection modules 40 make a structure having plural detectors relative to an X direction, and a state stacking the detection elements 50 in a Z direction (refer to FIG. 1 and FIG. 2).

Further, as for a Y direction, connection of the signal electrode 52 (52a, 52b, 52c, 52d) and the bias electrodes 53 from each of the detection modules 40, is connected to the wiring board 32, at a position of a Y direction side relative to each of the detection modules 40. In this case, as a member for connecting the signal electrode 52 and the bias electrodes 53 of the detection modules 40, and the wiring board 32, a wire-like or ribbon-like conductor is used.

The nuclear medicine diagnosis device is configured by arranging the detector array substrate 30 composed of the above, in multiple in a Z direction, and by arranging the detector array substrate 30 in a circular pattern at the circumference of the subject P, so that the Z direction becomes a body axis direction.

According to the embodiments of the present invention, the following effects are obtained:

(1) As shown in FIG. 2 and FIG. 3, by arranging the detection element 50 (refer to FIG. 5) patterned by the signal electrode 52 (52a, 52b, 52c, 52d) in an X direction of the circumference direction (refer to FIG. 2) of the PET device 1, dead space occupying ratio between the detection elements 50 in an X direction can be suppressed, dense arrangement becomes possible, and thus detection sensitivity can be enhanced. At the same time, spatial resolution can be also enhanced.
(2) By using the detection element 50 patterned by the signal electrode 52, detection pitch in an X direction can be adjusted freely, by adjusting width s of the signal electrode 52 shown in FIG. 5, which is a pattern width. That is, spatial resolution relative to an X direction of the circumference direction (refer to FIG. 2) of the PET device 1 can be enhanced.
(3) By mounting the plane 32a, where the wiring board 32 extends, and each signal electrode 52 and 53 of the detection element 50, onto the wiring board 32, so that they are in parallel, adhesive area of the wiring board 32 and the detection element 50, that is holding area can be maintained more, which increases supporting strength and enhances mechanical reliability.

Therefore, stable detection of γ-ray becomes possible. That is, generation of failures is suppressed and stable operation of the device is realized.

(4) As shown in FIG. 3, because of a configuration where signals from each of the detection modules 40 are read out relative to a Y direction of the direction where γ-ray injects mainly, as well as, in the detector array substrate 30, the CdTe semiconductors having the same potential face each other in a Y direction (refer to FIG. 3 and FIG. 2) of the direction, where γ-ray injects mainly, unnecessary cross-talk (deterioration of signal precision) of the detection signals relative to a Y direction can be suppressed. This leads to maintaining of good energy resolution, which is features of a semiconductor detector, resulting in to make possible to obtain a highly fine and highly quantitative image.
(5) As shown in FIG. 3, by connection to the wiring board 32 using the conductors 54 and 55, at a position of a Y direction side relative to each detection module 40, that is, a position along a Y direction, spatial occupation ratio of the detection element relative to an XZ plane (refer to FIG. 2), where γ-ray injects mainly, is possible to centralize. That is, γ-ray detection efficiency can be maximized, and detection sensitivity can be enhanced.
(6) By using a wire-like or ribbon-like conductor as the conductors 54, 55 of a connection member, scattering between the incident γ-ray and the conductors 54, 55, that is, decrease in detection efficiency can be minimized, and detection sensitivity relative to a Z direction can be enhanced, as well as occupation ratio of the detection element 50 in a Z direction increases and spatial resolution relative to a Z direction can be enhanced.
(7) Because a conventional metal plate was made unnecessary, density of the CdTe semiconductor of the detector array substrate 30 having the detection module 40 is enhanced, and γ-ray can be detected efficiently relative to a Y direction, where γ-ray injects mainly. Therefore, it is possible to enhance detection sensitivity of γ-ray, as well as enhance spatial resolution at the same time.

Accordingly, in the PET device 1, it is possible to provide a highly fine and highly quantitative image.

(8) Because a conventional metal plate was made unnecessary, material cost is solved, as well as production becomes easy due to elimination of the attaching step of the metal plate.

It should be noted that, in the present embodiment, the case, where the detection module 40 was fixedly set up at both of the planes 32a of the wiring board 32, was exemplified, however, the detection module 40 may be fixedly set up at one plane 32a of the wiring board 32.

In addition, the case, where the two detector array substrates 30 were arranged in a Z direction of the body axis direction of the subject P, was exemplified, however, it is possible to arrange arbitrary number of the detector array substrates 30.

In addition, each length and number exemplified in the present embodiment are only one example, and they should not be limited to these numerical values.

It is apparent to those skilled in the art that, although the above description has been made on examples, the present invention should not be limited thereto, and various changes and modifications can be made within the spirit of the present invention and the scope of the appended claims.

1. A detector array substrate arranged with detection elements which detects a radiation by converting to electric signals, in an XYZ space formed by a Z direction, which is the same direction as a body axis of a subject, a Y direction, which is nearly the same direction as an incident direction of radiation from a radioactive material in said subject, and an X direction, which is vertical to a ZY plane formed by said Z direction and said Y direction, comprising:
a flat detection module stacked in plural said detection elements, which is connected to said detectors each other, and have signal electrodes which reads out signals of said respective detectors and bias electrodes which applies bias voltage to said respective detectors, in order to form plural detectors which detects said radiation;
wherein said detectors are stacked by arranging the detection modules having said plural detectors in said X direction, as well as by arranging said detection modules in a flat structure on both planes or one plane of the wiring board in said Z direction, as for the XZ plane for detecting said radiation, and
said plural detection modules are provided in said Y direction.

2. The detector array substrate according to claim 1, wherein connection between said signal electrodes in said respective detection modules and said wiring board, and connection between said bias electrodes and said wiring board are configured, so as to be carried out along a Y direction relative to said respective detection modules, respectively.

3. The detector array substrate according to claim 1, wherein detection elements in said detection modules are joined each other via electrically conductive adhesives.

4. The detector array substrate according to claim 1, wherein said detection modules are joined onto said wiring board via electrically conductive adhesives.

5. The detector array substrate according to claim 1, wherein the detectors of said plural detection modules are arranged in adjacent to the same voltage side, in said Y direction.

6. The detector array substrate according to claim 1, wherein a member which connects the signal electrodes and the bias electrodes in said detection modules with said wiring board is a wire-like or ribbon-like conductor.

7. A nuclear medicine diagnosis device comprising a detector array structure where the detector array substrate according to claim 1 is arranged in multiple in said Z direction.

8. The nuclear medicine diagnosis device according to claim 7, wherein said detector array structure is arranged in a circular pattern around the body axis direction of said subject.

9. The detector array substrate according to claim 1, wherein said flat structure is a structure in which said detection modules is mounted on the wiring board, so that the plane of said wiring board and the electrode plane of said bias electrodes of said detection modules are in parallel in the XY plane.
